(19) United States
(12) Patent Application Publication
(10) Pub. No.: US 2015/0307248 A1
(43) Pub. Date: Oct. 29, 2015

(54) LOCKABLE PACKAGING AND AUXILIARY CLIP THEREFOR

(71) Applicant: MeadWestvaco Corporation, Richmond, VA (US)

(72) Inventors: Tanuja A. Patwardhan, Richmond, VA (US); Thanhhung N. LE, Henrico, VA (US)

(21) Appl. No.: 14/692,009

(22) Filed: Apr. 21, 2015

Related U.S. Application Data
(60) Provisional application No. 61/984,109, filed on Apr. 25, 2014.

(51) Int. Cl. B65D 67/02; F16B 2/10; B65D 77/04

(52) U.S. Cl. CPC B65D 67/02; B65D 77/04; F16B 2/10

(57) ABSTRACT

A combination includes a lockable package (710) and an auxiliary clip (100). The package has an outer container (709) and a lockable receptacle (790). The package includes a two-part locking mechanism for locking the lockable receptacle within the outer container. The outer container has a first part (740) of the two-part locking mechanism whereas the lockable receptacle has a second part (795) of the two-part locking mechanism. The outer container also has a release mechanism (760) for deactivating the two-part locking mechanism for withdrawal of the lockable receptacle. The auxiliary clip has at least two legs (106, 102a) and is fittable onto the package in the region of the release mechanism for applying a force directed such that the release mechanism is activated.

### FIELD OF THE INVENTION

The present invention relates generally to packaging, specifically but not exclusively, to lockable packaging such as child-resistant, senior-friendly packages for healthcare type applications and optionally to packaging such as sleeve-and-drawer style packages for consumer goods such as food, recreational drugs (e.g., tobaccos, cigars, cigarettes, etc.), toys, hardware, and electrical items, or the like. More specifically, but not exclusively, the invention relates to a sleeve-and-drawer style package having an internal slidable lockable receptacle, that is releasably lockable within an outer shell; and to an auxiliary clip for use in activating a release mechanism to unlock the lockable receptacle. Typical examples of sleeve-and-drawer packages where the present invention may be employed include, but are not limited to: unit dose packages for pharmaceutical tablets; capsules; lozenges; and security packages to deter package pilferage for small high-value items, such as consumer electronics.

### BACKGROUND OF THE INVENTION

In the field of packaging, particularly in the field of healthcare and medication packaging and in the field of sleeve-and-drawer style packaging for a wide range of consumer goods, it is often required to provide consumers or patients with secure packaging that has child-resistant features to restrict or prevent access to the package contents by a child. At the same time, it is useful for the intended user to be able to access the products contained within the package with some degree of ease. As such it is beneficial if the packaging is also “senior-friendly”. Many packages are available that comprise an inner slide card or drawer that holds articles in blisters or in trays. The inner slide card, with the articles, is then slidable inside an outer sleeve or outer shell. The inner slide card is usually retained and locked inside the outer sleeve by a locking element (e.g., a locking tail flap, a locking rivet, etc.) that engages the outer sleeve. An unlocking mechanism is usually provided on the outer sleeve to permit the disengagement of the inner slide card from the outer sleeve. Such unlocking mechanisms often require some dexterity to operate or require user realisation that co-ordinated operation of more than one feature is required; this may make the package child-resistant. In some instances, this may also make the package less senior friendly than is desirable. It is therefore desirable to improve the senior friendliness of packages without greatly compromising the child resistant features.

Further considerations in this technical field are the need for such packages to be reopened and relocked many times without failure. It is also desirable to keep the cost of the packaging as low as possible, whilst maintaining its durability. Whilst it is also advantageous to provide clearly printed information (such as pill calendars and/or other patient directed information) on the package, the size of the package is preferably minimised, not only to reduce its production costs by using less material, but also to reduce shipping costs. A light-weight and compact package, with a locking and unlocking feature that can withstand repeated use is therefore advantageous.

The present invention seeks to provide an improvement in the field of packaging, more specifically, but not exclusively, in the field of sleeve-and-drawer style packages.

### SUMMARY OF THE INVENTION

According to an aspect of the invention for which protection is sought, there is provided a kit or combination of a package and an auxiliary clip, in which the package comprises an outer container and a lockable receptacle. The outer container has a cavity for the lockable receptacle and has an open or openable end through which the lockable receptacle is inserted. The package comprises a two-part locking mechanism for locking the lockable receptacle within the cavity of the outer container. The outer container comprises a first part of the two-part locking mechanism while the lockable receptacle comprises a second part of the two-part locking mechanism. The outer container comprises a release mechanism for deactivating the two-part locking mechanism for withdrawal of the lockable receptacle at least partially from the outer container. The auxiliary clip comprises at least two legs and is fittable onto the package in the region of the release mechanism for applying a force directed such that the release mechanism is activated and the lockable receptacle released.

Optionally, the release mechanism comprises a deflectable tab, deflection of which tab causes movement of the lockable receptacle which disengages the second part of the two-part locking mechanism comprised by the lockable receptacle from the first part of the two-part locking mechanism comprised by the outer container. The deflectable tab may be defined by a substantially U-shaped cut and may be visible from the outside of the container or may be disclosed entirely internally of the outer container.

Optionally, the auxiliary clip comprises at least one upper leg and at least a first lower leg, hingedly coupled together by a resiliently biasing member such that the at least a first lower leg and the at least one upper leg together are moveable between an open condition and a closed condition and where, in the closed condition, the upper and lower legs are biased toward one another for application of a force onto the package.

Optionally, the auxiliary clip further comprises a second lower leg, wherein the second lower leg is laterally spaced from the first lower leg and wherein the upper leg is laterally spaced between the first and second lower legs and is longitudinally spaced above the first and second lower legs.

The at least a first lower leg and the at least one upper leg may each comprise a foot having a substantially flat surface, each foot may be in contact with the package when the auxiliary clip is attached thereto.

Optionally, in the open condition the maximum distance between the at least one upper leg and the at least a first lower leg is greater than the maximum distance between the at least one upper leg and the at least a first lower leg when the auxiliary clip is in the closed condition.

The outer container preferably comprises a top wall and a bottom wall and the depth of the outer container may be defined as the maximum distance therebetween when the auxiliary clip is not applied to the package. In the open condition the maximum distance between the at least one upper leg and the at least a first lower leg may be greater than said depth of the outer container and where, the maximum distance between the at least one upper leg and the at least a first lower leg when the auxiliary clip is in the closed condition may be less than said depth.

Optionally, the outer container comprises one or more guiding elements for assisting in the proper location of the auxiliary clip.

Optionally, the one or more guiding elements comprise a pair of grooves, a pair of ribs, a shaped portion and/or a recess or notch formed at the rear-end of the outer container.

Optionally, the outer container comprises one or more pressing zones configured and/or arranged proximate to the release mechanism such that a force applied and directed inwardly of the outer container toward the cavity activates the release mechanism and deactivates the two-part locking mechanism, and wherein the auxiliary clip is fittable onto the package such that at least one leg of the clip is disposed on one of said one or more pressing zones.

Optionally, the at least a first leg and the at least one upper leg each have a length that is sufficient for the auxiliary clip to be disposed such that at least one foot at least partially overlays at least one of said one or more pressing zones.

Except for said open or openable end, each other external surface of the outer container is preferably, but nevertheless optionally, free of a full-depth cut.

Optionally, upon proper insertion of the lockable receptacle within the cavity, the two-part locking mechanism is automatically activated and wherein the lockable receptacle is inserted into and is withdrawn from the cavity via the open or openable end of the outer container.

The package may comprise two pressing zones, wherein a first of the two pressing zones may be disposed on and/or within a first external face of the outer container and wherein the second of the two pressing zones may be disposed on and/or within a second external face of the outer container and wherein the first and second external faces may be spaced apart and disposed opposite to one another.

Optionally, the auxiliary clip is structured and configured such that the foot of the at least one upper leg contacts the first of the two pressing zones, wherein the foot of the first lower leg either contacts the second of the two pressing zones or is disposed adjacent thereto and wherein the foot of the second lower leg either contacts the second of the two demarcated pressing zones or is disposed adjacent thereto.

A notional line between the first and second pressing zones may be substantially orthogonal to a notional tubular axis extending through the outer sleeve.

The one or more pressing zones may be demarcated pressing zones. The one or more demarcated pressing zones may encourage correct placement of the auxiliary clip such that a localised force is appropriately applied to the package, by the auxiliary clip in its closed configuration, for causing disengagement of the locking mechanism. The one or more demarcated pressing zones have a shape selected from the group comprising: circular, irregular in shape, square, rectangular, triangular, oval, elliptical or rounded. The one or more demarcated pressing zones may be each printed with graphical indicia to highlight the region where a user of the package should affix the auxiliary clip.

Optionally, the outer container comprises a top wall and a bottom wall and wherein only one demarcated pressing zone is provided and the demarcated pressing zone is provided on the top wall.

Optionally, the one or more demarcated pressing zones comprise a physical formation and wherein the physical formation is any one or more or a combination of: an embossment, a debossment, a groove, a compression, a half-depth cut, a raised button, a recessed button.

Optionally, the first part of the two-part locking mechanism comprises a locking edge disposed internally of the outer container and wherein the one or more demarcated pressing zones do not overlap in superposition with the locking edge.

Optionally, the one or more demarcated pressing zones are positioned closer to a rear end of the outer container than the first part of the locking mechanism in the outer shell is positioned to the rear end of the outer container.

Optionally, wherein the one or more demarcated pressing zones may correspond to a focal point for the desired force to be applied for effecting disengagement of the two-part locking mechanism.

According to another aspect of the invention for which protection is sought, there is provided an auxiliary clip for use with the package defined in any of the preceding paragraphs, the auxiliary clip comprising at least one upper leg and at least a first lower leg hingedly coupled together by a resiliently biasing member such that the at least a first lower leg and the at least one upper leg together are moveable between an open condition and a closed condition and where, in the closed condition, the upper and lower legs are biased toward one another for application of a force onto a package.

Optionally, the auxiliary clip further comprises a second lower leg, wherein the second lower leg is laterally spaced from the first lower leg and wherein the upper leg is laterally spaced in-between the first and second lower legs and is longitudinally spaced above the first and second lower legs.

Optionally, the at least a first leg and the at least one upper leg each comprise a foot having a substantially flat surface.

Optionally, a foot of the at least one upper leg is disposed in a different notional plane to a foot of the first lower leg and to a foot of the second lower leg and wherein the foot of the first lower leg and the foot of the second lower leg are disposed in the same notional plane.

Optionally, each foot is disposed in contact with the package when the auxiliary clip is attached thereto.

Optionally, in the open condition the maximum distance between the at least one upper leg and the at least a first lower leg is greater than the maximum distance between the at least one upper leg and the at least a first lower leg when the auxiliary clip is in the closed condition.

Within the scope of this application it is envisaged and intended that the various aspects, embodiments, examples, features and alternatives set out in the preceding paragraphs, in the claims and/or in the following description and drawings may be taken independently or in any combination thereof. For example, features described in connection with one embodiment are applicable to all embodiments unless there is incompatibility of features.

### BRIEF DESCRIPTION OF THE DRAWINGS

Embodiments of the invention will now be described, by way of example only and with reference to the following drawings:

FIG. 1 is a plan view of a blank cut, creased and arranged for forming an outer-shell type container according to an aspect of the invention;

FIG. 2A is a cross-sectional view of a lockable receptacle of the type having a locking tail flap for use with an outer-shell formed from the blank of FIG. 1 in forming a sleeve-and-drawer style package according to an aspect of the invention;

FIG. 2B is a cross-sectional view of such a sleeve-and-drawer style package showing the engagement of the locking tail flap with the outer-shell type container;

FIG. 2C is a cross-sectional view of the package of FIG. 2A illustrating the unlocking operation of the package;

FIG. 3 is a plan view of a blank of material cut, creased and arranged for forming an outer-shell type container according to a further aspect of the invention;

FIG. 4A is a perspective view of the package formed from the blank of FIG. 3 showing a lockable receptacle disposed therein;

FIG. 4B is a perspective view of the lockable receptacle disposed in the package of FIG. 4A;

FIG. 4C is a side view of the lockable receptacle disposed in the package of FIG. 4A;

FIG. 5A is side view of a clip for use with a package, for example, either of the packages formed from the blanks of FIGS. 1 and 3, showing the clip in an open configuration;

FIG. 5B is side view of the clip of FIG. 5A in a closed configuration;

FIG. 5C is perspective view of the clip for use with a package, for example the packages formed from the blanks of FIGS. 1 and 3 showing the clip in a closed configuration;

FIG. 5D is perspective view of the clip of FIG. 6A in an open configuration; and

FIG. 6A is a perspective view of the package formed from the blank of FIG. 1, having a lockable receptacle disposed and locked therein and showing the clip of FIGS. 5A and 5B disposed in a closed position thereon for deactivation of a locking mechanism for release of the lockable receptacle;

FIG. 6B is a view taken from the line Y-Y′ of the package and auxiliary clip of FIG. 6A, looking in the direction shown by the arrows in FIG. 6A, illustrating how the auxiliary clip has activated the unlocking or release mechanism to release the lockable receptacle from the outer container of the package;

FIG. 7A is a similar view as shown in FIG. 6B, but of the package formed from the blank of FIG. 3, having a lockable receptacle disposed and locked therein and showing an auxiliary clip according to an embodiment of the invention disposed in an open position thereon; and

FIG. 7B is a similar view as shown in FIG. 7A with the auxiliary clip in a closed configuration, illustrating how the auxiliary clip has activated the unlocking or release mechanism to release the lockable receptacle from the outer container of the package.

### DETAILED DESCRIPTION OF THE PREFERRED EMBODIMENTS

Detailed descriptions of specific embodiments of the outer-shells, lockable receptacle, packages, auxiliary clips and blanks are disclosed herein. It will be understood that the disclosed embodiments are merely examples of the way in which certain aspects of the invention can be implemented and do not represent an exhaustive list of all of the ways the invention may be embodied. Indeed, it will be understood that the outer-shells, lockable receptacle, packages, auxiliary clips and blanks described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

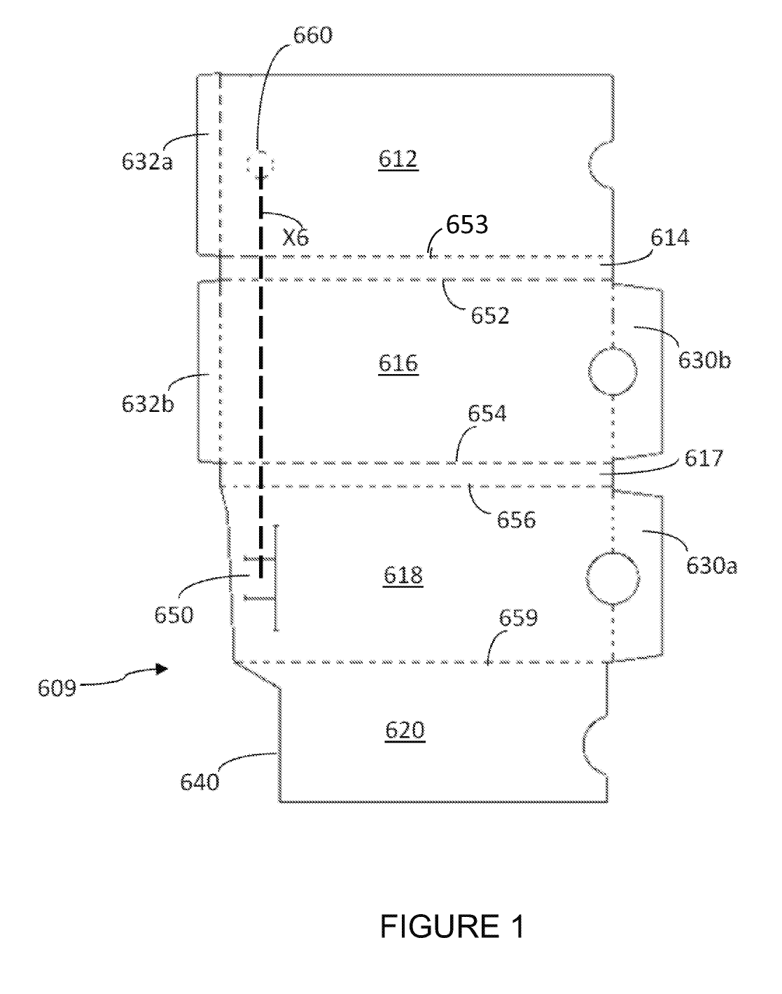

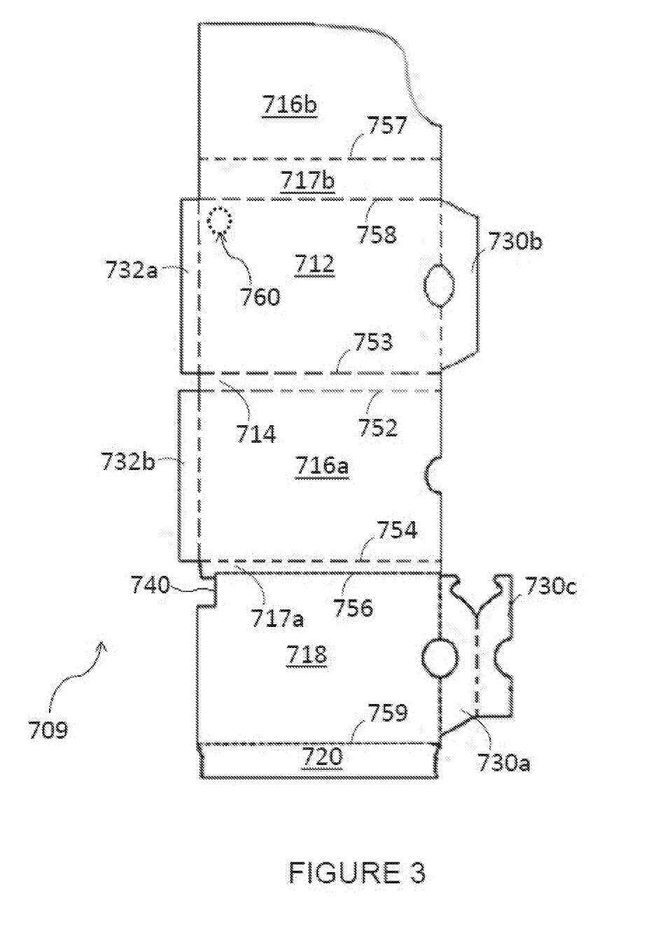

Reference is now made to the accompanying FIGS. 1 to 7B for the purpose of describing, in detail, preferred and exemplary embodiments of the present disclosure. The Figures and detailed description are provided to describe and illustrate examples in which the disclosed container may be made and used, and are not intended to limit the scope thereof. Those skilled in the art will readily appreciate that the disclosed containers can be used to store a variety of products. More specifically, the disclosed containers can be used for the storage of products, such as for example, medications, drugs, tablets, electrical items such as chips and small PCBs, smokeless tobacco, cigarettes, confectionery, cigarettes, tea bags or any product stored in a pouch or blister, mints, and the like without departing from the inventive aspects of the present disclosure. In the Figures like reference numerals have where possible been used to denote like features, as such features of the outer container 610 and blank 609 for forming the same shown in FIGS. 1, 2A, 2B, 2C, 6A and 6B are numbered with reference numerals in the “600's”, similar features of the embodiment of outer container and blank therefor illustrated in FIGS. 3, 4A to 4C, 7A and 7B have been given similar reference numerals albeit in the “700's” to distinguish them clearly from the features of the first embodiment.

Generally, the present invention teaches the provision of a method of unlocking a container 610, 710 or of disengaging a locked inner receptacle 690, 790 from an outer-sleeve 610, 710 or outer container 610, 710 using an auxiliary clip 100, 200. According to a preferred, but nevertheless optional, aspect of the invention the externally facing walls or panels of the outer-sleeve or outer container 610, 710 are free from cut lines that, in the prior art, are used to define and form unlocking mechanisms or release mechanisms in the form of tabs or buttons. As such the externally facing walls 612, 614, 616, 617; 712, 717b, 714, 716a/716b of the outer-sleeves or outer-containers 610, 710 of embodiments of the present invention are uninterrupted or smooth or in other words retain their structural integrity. This is advantageous because cut-lines and moveable release tabs that can move relative to the plane of an external wall or panel provide an entry point for the ingress of air, dust or dirt. Where product freshness is a consideration, ingress of air, dust and dirt is a problem. Furthermore, cut out release tabs or buttons provided on external walls or panels can become damaged and sometimes deliberately so prior to purchase of the package. As such, cut release tabs can provide a point of weakness in the package which may enable a thief to access the package contents prior to purchase. Nevertheless, aspects of the disclosure are applicable also to outer-containers having a release mechanism formed by a cut or frangible portion in an external wall of the outer-container.

The present invention provides an auxiliary clip 100 for use with such outer containers 610, 710 that is co-operative with a release mechanism 650 or locking mechanism 640, 740 provided on or within the outer container 610, 710, which auxiliary clip 100 disengages a lock between the outer-shell type container 610, 710 that specifically eliminates the requirement for a user to apply a force themselves. The auxiliary clip 100 is particularly beneficial when used with outer containers 610, 710 having a pressing zone 660, 760 on the outer container 609, 709 which is pressed or depressed by the auxiliary clip 100 in order to effect unlocking of the lockable receptacle 690, 790 from the outer container 610, 710

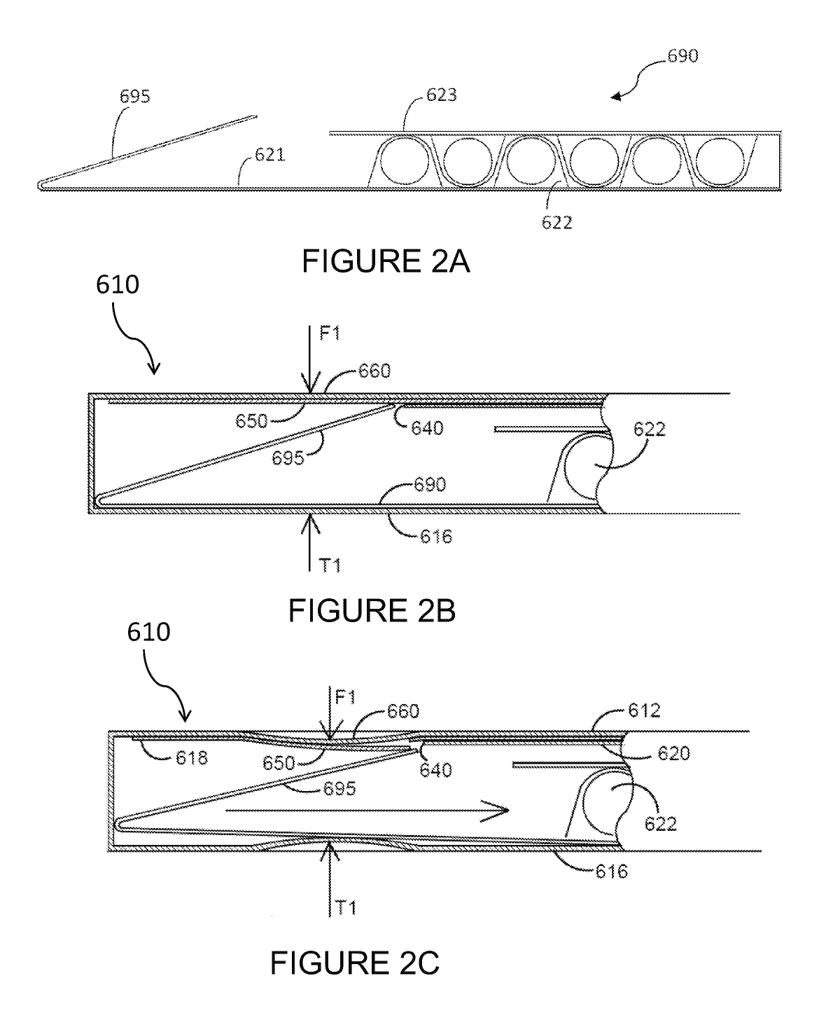

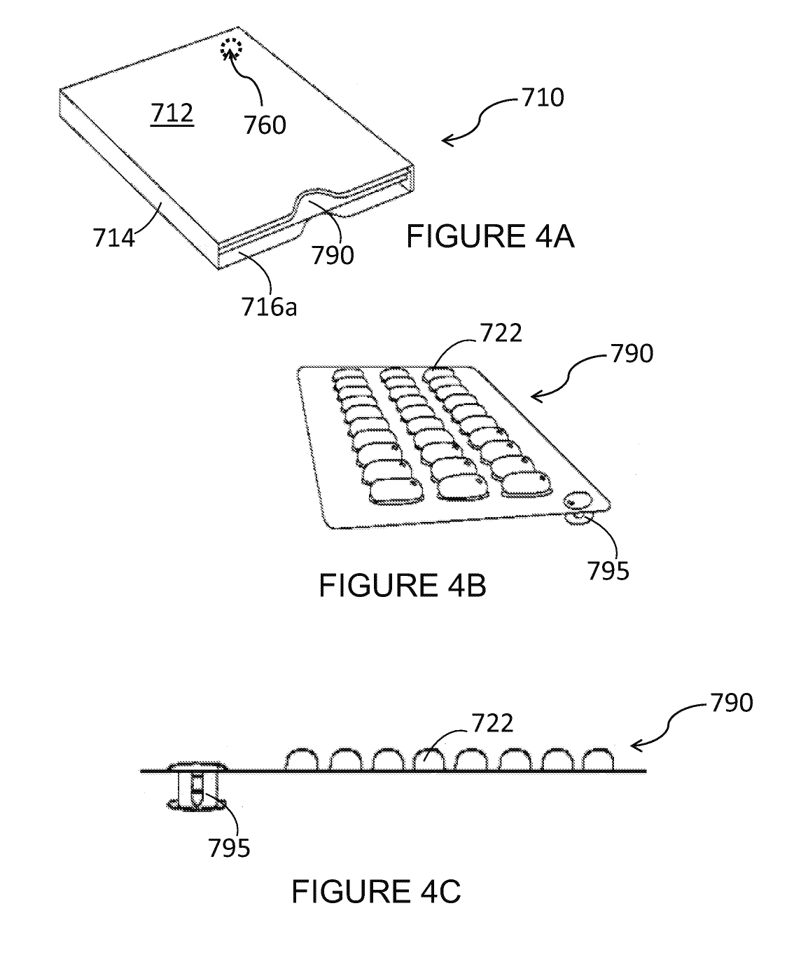

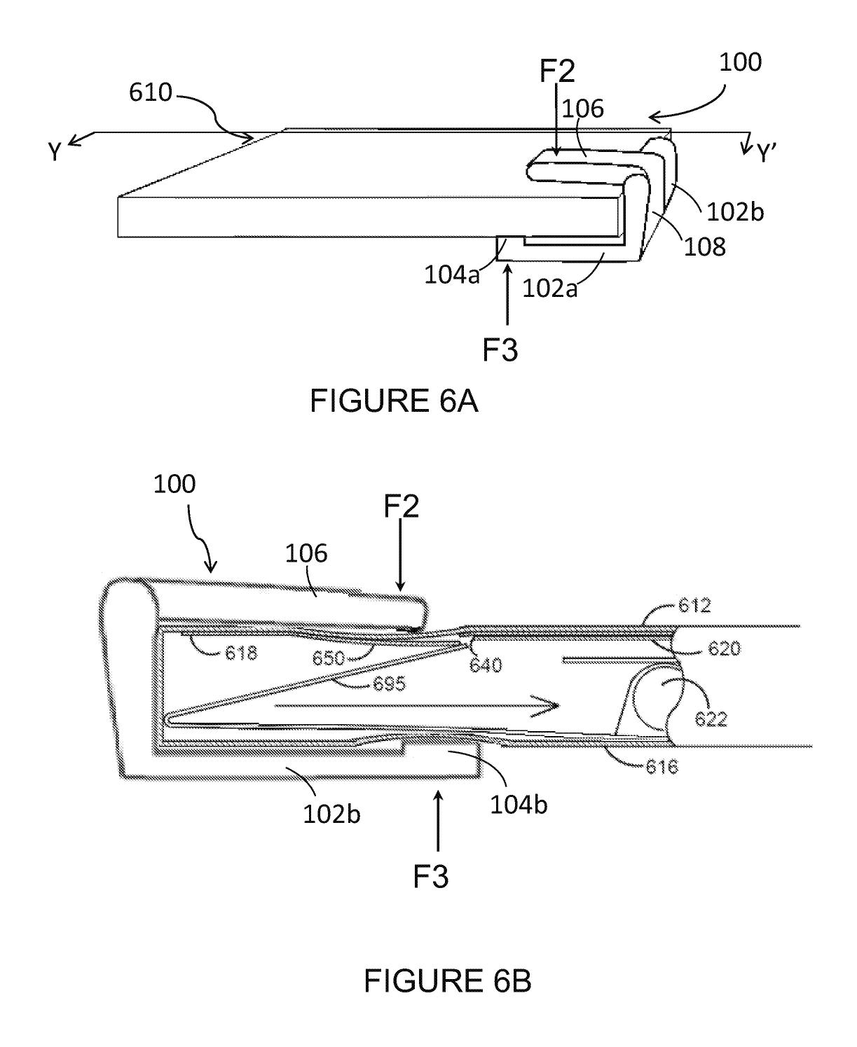

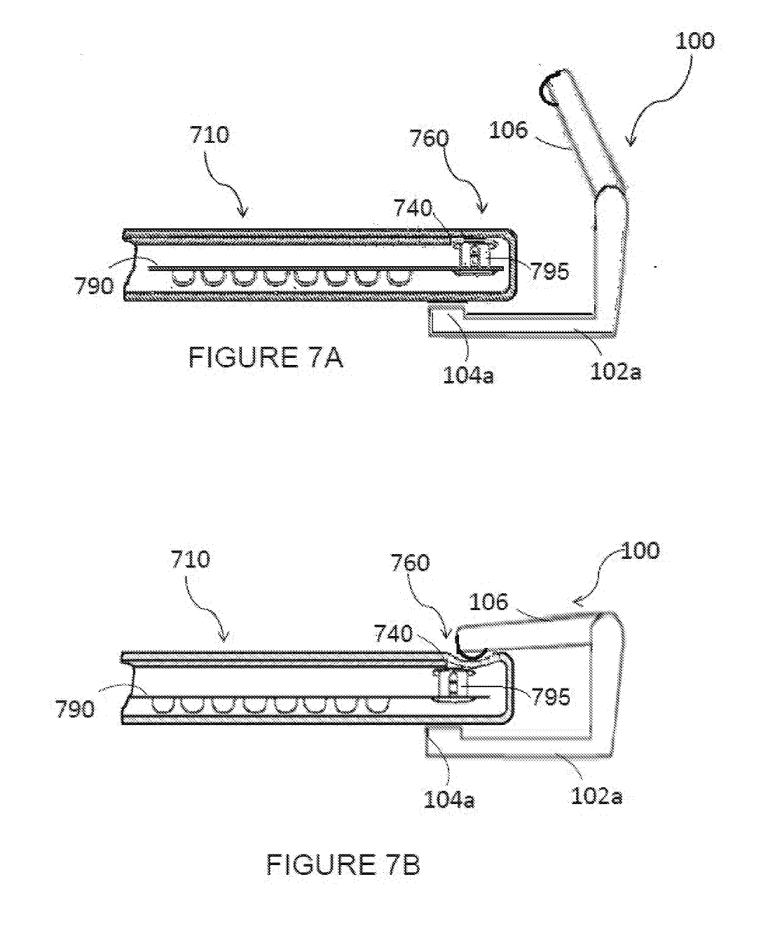

FIG. 1 illustrates a blank 609 forming a first exemplary outer container 610, and FIGS. 2A to 2C illustrate the first exemplary outer container 610 in an erected form with a lockable receptacle 690, that may be used in conjunction with the auxiliary clip 100 of the present disclosure, as illustrated in FIGS. 6A and 6B. FIG. 3 illustrates a blank 709 forming a second exemplary outer container 710, and FIGS. 4A to 4C illustrate the second exemplary outer container 710 in an erected form with a lockable receptacle 790, that may be used in conjunction with the auxiliary clip 100 of the present disclosure, as illustrated in FIGS. 7A and 6B. However, it will be recognized upon reading the foregoing that the auxiliary clip 100 of the disclosure may be utilized with other exemplary outer containers to provide a package that whilst retaining its child-resistance features is more senior friendly and that the application of an auxiliary clip 100 to outer containers other than those illustrated is envisaged.

Referring now to FIG. 1, there is shown a blank 609 for forming an outer shell type container for use in creating a sleeve-and-drawer style package 610 (shown in cross-section in FIGS. 2B and 2C). The blank 609 is formed from a sheet of suitable substrate. It is to be understood that, as used herein, the term “suitable substrate” includes all manner of foldable sheet material such as paperboard, corrugated board, cardboard, plastic, combinations thereof, and the like. It should be recognized that one or other numbers of blanks may be employed, where suitable, for example, to provide the carrier structure described in more detail below. The blank 609 shown in FIG. 1 is formed from paperboard, optionally having at least one coated and printed side.

Blank 609 forms an outer container 610 (see FIGS. 2B and 2C) for use with a lockable receptacle 690 shown in FIG. 2A. The blank 309 comprises an outer top panel 612 with a first demarcated pressing zone 660. A pair of side panels 614, 617 hingedly connects a bottom panel 616 to the outer top panel 612 and to a first inner top panel 618 via fold lines 653, 652, 654 and 656. A second inner top panel 620 is hingedly connected via fold line 659 directly to the first inner top panel 618 along a fold line 659. The first inner top panel 618 forms an intermediate top panel 618 disposed between the outer top panel 612 and the second inner top panel 620. The second inner top panel 620 forms an innermost top panel 620. End closure panels 632a, 632b are hingedly connected to the rear ends of the outer top panel 612 and bottom panel 616 and are folded relative thereto and affixed together to form a composite rear end wall. Optionally flaps 630a, 630b are hingedly connected to the front ends of the bottom panel 616 and first inner top panel 618. A stopper flap 630a once folded and optionally adhered to an internal face of the first inner top panel 618 provides an edge against which the lockable receptacle 690 is optionally caught in order to prevent or restrict the lockable receptacle 690 from being completely withdrawn from the outer-container 610 formed from the blank 609.

A first-part of a two-part locking mechanism is provided by a locking edge 640 of the second inner top panel 620. The locking edge 640 provided by the second inner top panel 620 is for catching or engaging a second part of the two-part locking mechanism that is provided by a locking element (locking tail flap) 695 of the lockable receptacle 690. Optionally, a flexible or displaceable release tab 650 is formed in the first inner top panel 618 and is arranged to be adjacent the locking edge 640 when the blank 609 is in a set-up condition. The release tab 650 is anchored at one end, which end is integrally formed with the first inner top panel 618 and is free to flex or bend such that an opposite end is displaceable, when depressed by a user, to disengage the locking element 695 of the lockable receptacle 690 from locking engagement with the locking edge 640. Thereby, the release tab 650 forms at least part of a release mechanism.

The optional inner release tab 650 is formed by an arrangement of appropriately sized and positioned cut lines. The release tab 650 is displaceable out of the plane of the first inner top panel 618 and is provided to transfer a downwardly applied force to the locking tail flap 695 of a lockable receptacle 690 (see FIG. 2A for a cross-sectional view of the lockable receptacle; FIG. 2B for a cross-section of the outer container having the lockable receptacle disposed and locked therein; and FIG. 2C for an illustration of the manner in which unlocking of the lockable receptacle 690 from the outer container 610 can be achieved).

A pressing zone 660, which is optionally demarcated by an indicia, is positioned such that its centre is directly over or at least substantially over the centre of the release tab 650 when the outer container 610 is formed from the blank 609. This alignment is illustrated in FIG. 1 by means of dashed notional line X6. The centre of the demarcated pressing zone 660 is off-set from the engaging edge 640 and off-set closer to the rear-closed-end 632a/632b of the outer container 610. The front end of the outer container 610 is open and is optionally edged by inwardly folded panels 630a, 630b.

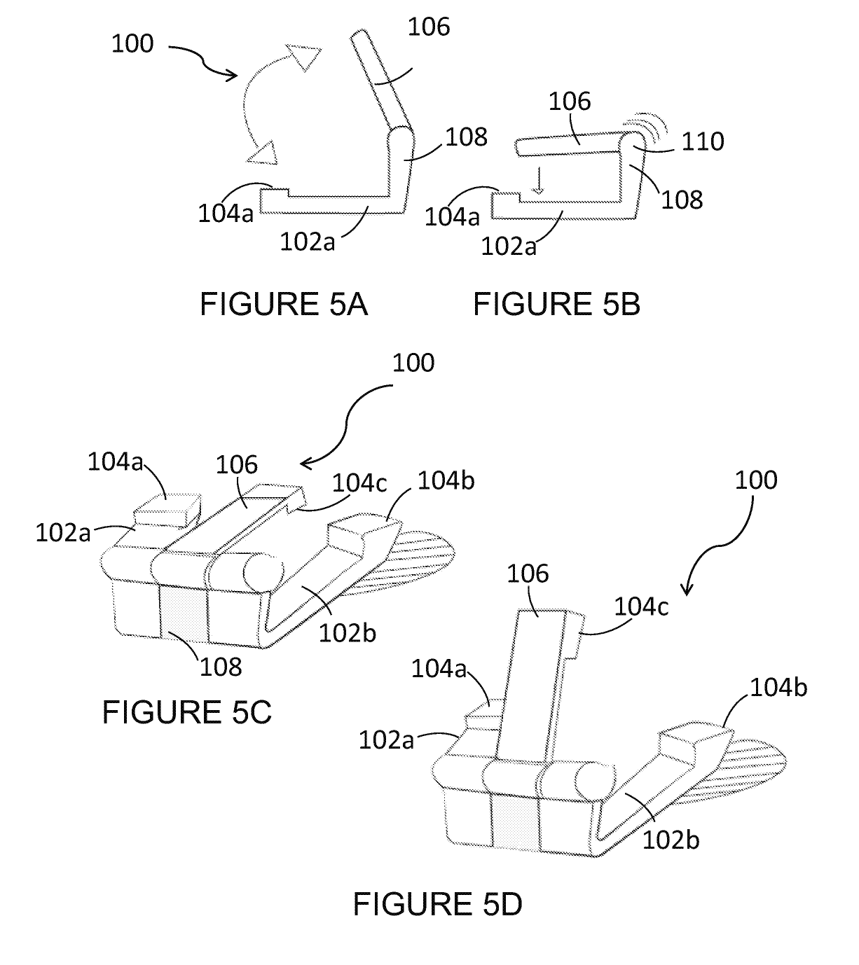

The outer container 610 is formed from the blank 609 by folding and affixing the panels. An optional sequence of construction is to firstly fold the stopper flaps 630a, 630b inwardly and into face contacting relationship with the first inner top panel 618 and the bottom panel 616 respectively. The second inner top panel 620 may be folded and affixed (optionally by means of hot melt adhesive) to the first inner top panel 618. The blank 609 is folded and manipulated to bring the outer top panel 612 into face-contacting relationship and into an affixed state with the other side of the first inner top panel 618. Upon opening the part-formed outer container 610 into a tubular structure, by folding the side panels 614, 617 out of the plane of the outer top panel 612 and bottom panel 616, the end closure panels 632a, 632b can be affixed together the form a secure end wall. The lockable receptacle 690, with its blisters 622 and optional fold over flap 623 can be inserted into the cavity of the outer container 610. The locking tail flap 695 of the lockable receptacle 690 is folded relative to a main body portion 621 thereof and as such has a tendency to return to its unfolded state. The natural resilience of the material from which the lockable receptacle body 621 and tail flap 695 are formed ensures this and this feature is useful for ensuring a good engagement between the second part of the two part locking mechanism, the locking tail flap 695 and the first part 640 the two part locking mechanism (695 and 640), the locking edge 640. This is illustrated in FIG. 2A.

Whereas a user may optionally apply force to the outer container 610 by squeezing the package between their thumb and forefinger (as illustrated by inwardly directed arrows T1 and F1 in FIG. 2C), the present invention provides an auxiliary clip 100 (see FIGS. 5A to 6B) which mimics or simulates at least partially, the application of force by a human hand. The auxiliary clip 100 (which is further described below) is affixed to the outer container 610 and in its closed configuration, applies an appropriate force F2, F3 at a suitable location for activating the release mechanism 650 (see FIG. 6B). The provision of the demarcated pressing zone 660 may show a user or where to position the auxiliary clip 100 in order that the applied force F2, F3 is correctly directed for unlocking the inner receptacle 690. The guidance provided by the demarcated pressing zone 660 may be written; pictorially illustrated; and/or provided by a depression, embossment or creased circle as examples.

In the illustrated arrangement of FIGS. 1 to 2C, 6A and 6B, the outer top panel 612 comprises a demarcated pressing zone 660 which provides a latent pressure point which is beneficial because unlike typical release tabs, the outer most top panel 612 is free of any cuts of tears that could be torn out or that could allow the ingress of dirt. The pressing zone 660, may be decorated, shaped, press-formed or otherwise formed as required to further disguise its presence or alternatively to highlight its presence.

Optionally, the demarcated pressing zone 660 may be positioned only on the outer top panel 612 or in envisaged embodiments, a demarcated pressing zone may be provided only on a bottom panel of an outer-sleeve style container. Alternatively, demarcated pressing zones may be provided on both top and bottom panels. It will be understood that depending upon the manner in which the locking mechanism operates, the demarcated pressing zone will be positioned and sized and arranged accordingly. As such, if a locking mechanism comprises two separate locking features, each of which requires disengagement for release of a lockable receptacle, then the outer sleeve style container may be provided with more than one demarcated pressing zone. Furthermore, it will be understand from consideration of FIGS. 3 to 4C that the presence of an internal release tab (such as tab 650) is an optional element and may be substituted by an apertured panel, by no inner top panel or by a plain inner top panel.

In FIG. 3, a blank 709 is shown wherein the inner top panel 718 has a notch or cutout at its left end corner next to the panel 717a. The notch defines an engaging edge 740, i.e., the first part of the two-part locking mechanism (740 and 795). The outer top panel 712 comprises a demarcated pressing zone 760 which is disposed proximate to and in vertical alignment with a locking rivet 795, i.e., the second part of the two-part locking mechanism, attached to the lockable receptacle (or blister card) 790 (see FIG. 4B). The lockable receptacle 790 is slidably or movably received in the erected outer container (or outer sleeve) 710 such that when a force is applied by depressing a demarcated pressing zone 760 and/or optionally by squeezing the bottom panel 716a and outer top panel 712 in the region of the demarcated pressing zone 760, the top panel 712 and optionally the bottom panel 716a are caused to bow or be depressed sufficiently to cause disengagement of the locking rivet 795 from the engaging edge 740 as is illustrated in FIG. 7B.

Turning in more detail now to the auxiliary clip 100, an example of an auxiliary clip 100 is shown on its own in FIGS. 5A to 5D and in conjunction with an outer container 610, 710 in FIGS. 6A, 6B, 7A and 7B. The auxiliary clip 100 is for use with a package such as an outer container 610, 710 having a lockable receptacle 690, 790 therein. The auxiliary clip 100 comprises at least one upper leg 106 and at least a first lower leg 102a, hingedly coupled together by a resiliently biasing member 110 such that the at least a first lower leg 102a, and the at least one upper leg 106 together are moveable between an open condition (see FIG. 5A) and a closed condition (see FIG. 5B). In the closed condition, the upper 106 and lower legs 102a, 102b are biased toward one another for application of a force onto a package.

In the illustrated embodiment, the clip 100 comprises a second lower leg 102b which is laterally spaced from the first lower leg 102a. The lateral spacing of the lower legs 102a, 102b is best viewed in FIGS. 5C and 5D. The upper leg 106 is both laterally spaced in-between the first and second lower legs and is longitudinally spaced above the first and second lower legs. A notional line connecting the ends 104a, 104b, 104c of the legs 102a, 102b, 102c would form a triangle of pressure points. Optionally, the ends 104a, 104b, 104c of the legs 102a, 102b, 102c each comprise a shaped foot having a substantially flat surface. The surface of the foot may in some embodiments be ribbed or textured in order to improve the grip or frictional contact between the clip 100 and an outer container 610, 710. The lateral and longitudinal spacing of the legs 102a, 102b 106 may be further understood by considering that the foot 104c of the at least one upper leg 106 is disposed in a different notional plane to the foot 104a of the first lower leg 102a and to the foot 104b of the second lower leg 102b and that the foot 104a of the first lower leg 102a and the foot 104b of the second lower leg 102b are disposed in the same notional plane. Preferably, none of the feet 104a, 104b, 104c (pressure points) of the lower legs 102a, 102b are disposed in perfect vertical registry with the upper leg 106 to ensure that the lockable receptacle 690, 790 is not clamped too tightly therebetween such that rather than being releasable from the outer container 610, 710 it is actually clamped and secured and locked more tightly. However a marginal degree or partial overlap of the lower pressure points (feet) 104a, 104b and the upper foot 104c may yet permit the release of the lockable receptacle 690, 790.

When the auxiliary clip 100 is attached to a package (a package may be considered as the combination of an outer container 610, 710 containing a lockable receptacle 690, 790 therein), an upper leg 106 is typically disposed on top of one primary panel (for example an outer top panel 612, 712) and the lower legs 102a, 102b are typically disposed against another spaced and opposite primary panel (for example a bottom panel 616, 716/716b). When the auxiliary clip 100 is in its clamping position (closed position) each foot 104a, 104b, 104c is disposed in contact with the package. The closed position is shown in FIGS. 5B, 5C, 6A, 6B and 7B. In the closed position, sufficient force is appropriately applied to deform or depress the pressing zone 660, 760 to cause the release of the lockable receptacle 690, 790.

Referring to FIGS. 5A and 5B, it can be seen that in the open condition the maximum distance between the at least one upper leg 106 and the at least a first lower leg 102a is greater than the maximum distance between the at least one upper leg 106 and the at least a first lower leg 102a when the auxiliary clip 100 is in the closed condition.

As described, the outer containers 610, 710 may comprise a top wall 612, 712 and a bottom wall 616, 716/716b and the depth of the outer container 610, 710 may be defined as the maximum distance therebetween when the auxiliary clip 100 is not applied to the package. In the open condition of the auxiliary clip 100, the maximum distance between the at least one upper leg 106 or upper foot 104c and the at least a first lower leg 102a or lower foot 104a is greater than said depth of the outer container 610, 710. The maximum distance between the at least one upper leg 106 (or foot 104c) and the at least a first lower leg 102a (or foot 104a) when the auxiliary clip 100 is in the closed condition is preferably less than said depth because a portion of the outer container has been depressed, or inwardly pressed.

While the present invention has been described in terms of specific embodiments thereof, it will be understood that no limitations are intended thereby to the details of construction or design, the present invention contemplating and including any novel feature or novel combination of features which are herein disclosed.

It can be appreciated that various changes may be made within the scope of the present invention, for example, the size, number, configuration, position and relative placement, shape and physical formation of the one or more demarcated pressing zones may be adjusted to suit the locking mechanism and/or size and/or colour and/or design and/or intended purpose of the package. Preferably, the entire pressing zone does not overlap (in superposition) with the engaging edge or engaging mechanism provided, however, in some embodiments there may be an overlap. Preferably, the centre (width-ways) of the demarcated pressing zone is aligned with the centre (width-ways) of an internal release tab when provided.

The one or more demarcated pressing zones may comprise any one or more of: an embossment, debossment, crease, groove, compressed region of material, integrally formed raised button and recess. Optionally the demarcated region may be formed by anyone or more or an appropriate combination of: thermo-forming, molded, blow-molded, pressed, grooved, engraved, scored, and hatched.

It will be appreciated that in some embodiments the auxiliary clip may be operated by a user applying a force to the legs of the auxiliary clip. In other embodiments the auxiliary clip may be resiliently biased for example by a spring mechanism. Alternatively, the auxiliary clip may employ the inherent resilience of the material from which the clip is formed, such that legs of the auxiliary clip must be spread apart to receive the outer container and the legs of the clip are biased to apply force to opposing sides.

In yet other embodiments the auxiliary clip may comprise a lever mechanism to apply a force to the outer container. The lever mechanism may comprise a pair of third-class lever mechanisms connected at a fulcrum located at one fixed end of the levers as shown in FIG. 5A to 5D, to operate in a similar fashion to tweezers. In still further embodiments the lever mechanism may comprise a pair of first-class lever mechanisms joined at a fulcrum positioned between the opposing ends of the levers crating a pair of jaws at one end of the clip and a pair of handles at the other so as to operate in a similar fashion to scissors or pliers. The jaws of the auxiliary clip may be resiliently biased into an open or preferably a closed condition.

It is envisaged that the auxiliary clip may employ an over centre mechanism which over centre mechanism provides a positive lock position when engaged similar to that employed by Locking pliers, Mole grips (Mole wrench) or Vise-Grips.

In some envisaged embodiments, the outer container may comprise one or more guiding elements for assisting in the proper location of the auxiliary clip. The one or more guiding elements may comprise a pair of grooves, a pair of ribs, a shaped portion and/or a recess or notch formed at the rear-end of the outer container for facilitating the correct location of the auxiliary clip onto the package such that it can effectively operate as a releasing mechanism. In yet other embodiments the auxiliary clip may comprise guide members for locating the auxiliary clip with respect to the outer container, for example the auxiliary clip may comprise one or more surfaces which when placed in contact with a respective surface of the outer container arrange the jaws of the auxiliary clip to be disposed over one or more pressing zones on the outer container.

It will be appreciated that the auxiliary clip assists the user to find the pressing zone; the auxiliary clip may be arranged such that when the outer container is fully inserted into the auxiliary clip a portion of the auxiliary clip is located over the pressing zone. In this way the auxiliary clip will apply force to the pressing zone irrespective of where a user applies pressure to the auxiliary clip.

It will be recognised that as used herein, directional references such as “top”, “base”, “front”, “back”, “end”, “side”, “inner”, “outer”, “upper” and “lower” do not limit the respective panels to such orientation, but merely serve to distinguish these panels from one another. It can be appreciated that various changes may be made within the scope of the present invention. For example, the size and shape of the panels and apertures may be adjusted to accommodate articles of differing size or shape.

As used herein, the term “fold line” refers to all manner of lines that define hinge features of the blank or substrate of sheet material, facilitate folding portions of the blank or substrate of sheet material with respect to one another, or otherwise indicate optimal panel folding locations for the blank or substrate of sheet material. Any reference to “hingedly connected” should not be construed as necessarily referring to a connection provided by a single fold line only; indeed “hingedly connected” may refer to a connection provided by one or more fold lines.

As used herein, the term “fold line” may refer to one of the following: a scored line, an embossed line, a debossed line, a line of perforations, a line of short slits, a line of half-cuts, a single half-cut, an interrupted cut line, aligned slits, a line of short scores and any combination of the aforesaid options, without departing from the scope of the invention.

It should be understood that hinged connections and fold lines can each include elements that are formed in the blank or substrate of sheet material, including perforations, a line of perforations, a line of short slits, a line of half-cuts, a single half-cut, a cut line, an interrupted cut line, slits, scores, any combination thereof, and the like. The elements can be dimensioned and arranged to provide the desired functionality. For example, a line of perforations can be dimensioned or designed with degrees of weakness to define a fold line and/or a frangible line. The line of perforations can be designed to facilitate folding and resist breaking to provide a fold line, to facilitate folding and facilitate breaking with more effort to provide a frangible fold line, or to facilitate breaking with little effort to provide a frangible line.

It should be understood that a demarcated pressing zone in this disclosure may be circular, irregular in shape, square, rectangular, triangular, oval, elliptical or rounded.

I should be further understood that a demarcated pressing zone in this disclosure may be printed with graphical indicia to highlight the region where a user of the package should apply a force.

It should further be understood that a demarcated pressing zone in this disclosure may comprise a physical formation and wherein the physical formation may be any one or more or a combination of: an embossment, a debossment, a groove, a compression, a half-depth cut, a raised button, a recessed button.

1. A combination comprising a package and an auxiliary clip, the package comprising an outer container and a lockable receptacle, the outer container having a cavity for receiving the lockable receptacle and having an open or openable end through which the lockable receptacle is inserted, the package comprising a two-part locking mechanism for locking the lockable receptacle within the cavity of the outer container, the outer container comprising a first part of the two-part locking mechanism and the lockable receptacle comprising a second part of the two-part locking mechanism, wherein the outer container comprises a release mechanism for deactivating the two-part locking mechanism for withdrawal of the lockable receptacle at least partially from the outer container, the auxiliary clip comprising at least two legs and being fittable onto the package in the region of the release mechanism for applying a force directed such that the release mechanism is activated and the lockable receptacle released.

2. A combination according to claim 1 wherein the release mechanism comprises a deflectable tab, deflection of which tab causes movement of the lockable receptacle which disengages the second part of the two-part locking mechanism comprised by the lockable receptacle from the first part of the two-part locking mechanism comprised by the outer container.

3. A combination according to claim 1 wherein the auxiliary clip comprises at least one upper leg and at least a first lower leg, hingedly coupled together by a resiliently biasing member such that the at least a first lower leg and the at least one upper leg together are moveable between an open condition and a closed condition and where, in the closed condition, the upper and lower legs are biased toward one another for application of a force onto the package.

4. A combination according to claim 3 further comprising a second lower leg, wherein the second lower leg is laterally spaced from the first lower leg and wherein the upper leg is laterally spaced between the first and second lower legs and is longitudinally spaced above the first and second lower legs.

5. A combination according to claim 3 wherein the at least a first lower leg and the at least one upper leg each comprise a foot having a substantially flat surface, each foot being in contact with the package when the auxiliary clip is attached thereto.

6. A combination according to claim 3 wherein the open condition the maximum distance between the at least one upper leg and the at least a first lower leg is greater than the maximum distance between the at least one upper leg and the at least a first lower leg when the auxiliary clip is in the closed condition.

7. A combination according to claim 6 wherein the outer container comprises a top wall and a bottom wall and wherein the depth of the outer container is defined as the maximum distance therebetween when the auxiliary clip is not applied to the package and where, in the open condition the maximum distance between the at least one upper leg and the at least a first lower leg is greater than said depth of the outer container and where, the maximum distance between the at least one upper leg and the at least a first lower leg when the auxiliary clip is in the closed condition is less than said depth.

8. A combination according to claim 1 wherein the outer container comprises one or more pressing zones configured and/or arranged proximate to the release mechanism such that a force applied and directed inwardly of the outer container toward the cavity activates the release mechanism and deactivates the two-part locking mechanism, and wherein the auxiliary clip is fittable onto the package such that at least one leg of the clip is disposed on one of said one or more pressing zones.

9. A combination according to claim 8 wherein the at least a first leg and the at least one upper leg each have a length that is sufficient for the auxiliary clip to be disposed such that at least one foot at least partially overlays at least one of said one or more pressing zones.

10. A combination according to claim 8 wherein except for said open or openable end, each other external surface of the outer container is free of a full-depth cut.

11. A combination according to claim 8 wherein the one or more pressing zones are demarcated pressing zones.

12. A combination according to claim 11 wherein the one or more demarcated pressing zones have a shape selected from the group comprising: circular, irregular in shape, square, rectangular, triangular, oval, elliptical or rounded.

13. A combination according to claim 11 wherein the one or more demarcated pressing zones are each printed with graphical indicia to highlight the region where a user of the package should affix the auxiliary clip.

14. A combination according to claim 11 wherein the one or more demarcated pressing zones comprise a physical formation and wherein the physical formation is any one or more or a combination of: an embossment, a debossment, a groove, a compression, a half-depth cut, a raised button, a recessed button.

15. A combination according to claim 11 wherein the first part of the two-part locking mechanism comprises a locking edge disposed internally of the outer container and wherein the one or more demarcated pressing zones do not overlap in superposition with the locking edge.

16. An auxiliary clip for use with the combination defined in claim 1, wherein the auxiliary clip comprises at least one upper leg and at least a first lower leg hingedly coupled together by a resiliently biasing member such that the at least a first lower leg and the at least one upper leg together are moveable between an open condition and a closed condition and wherein the closed condition, the upper and lower legs are biased toward one another for application of a force onto a package.

17. An auxiliary clip according to claim 16 further comprising a second lower leg, wherein the second lower leg is laterally spaced from the first lower leg and wherein the upper leg is laterally spaced in-between the first and second lower legs and is longitudinally spaced above the first and second lower legs.

18. An auxiliary clip according to claim 16 wherein the at least a first leg and the at least one upper leg each comprise a foot having a substantially flat surface.

19. An auxiliary clip according to claim 18 wherein a foot of the at least one upper leg is disposed in a different notional plane to a foot of the first lower leg and to a foot of the second lower leg and wherein the foot of the first lower leg and the foot of the second lower leg are disposed in the same notional plane.

20. An auxiliary clip according to claim 16 wherein the open condition the maximum distance between the at least one upper leg and the at least a first lower leg is greater than the maximum distance between the at least one upper leg and the at least a first lower leg when the auxiliary clip is in the closed condition.
